(19) United States
(12) Patent Application Publication
(10) Pub. No.: US 2007/0249249 A1
(43) Pub. Date: Oct. 25, 2007

(54) High elasticity compound material

(75) Inventors: I-Jye Chen, Tainan (TW); Ting-Sheng Huang, Tainan (TW); Ching-Hui Lee, Tainan (TW)

Correspondence Address: PATENTTM.US, P. O. BOX 82788, PORTLAND, OR, 97282-0788, US

(73) Assignee: NAM LIONG ENTERPRISE CO., LTD.

(21) Appl. No.: 11/377,334

(22) Filed: Mar. 15, 2006

(51) Int. Cl. B32B 7/12; B32B 27/04

(52) U.S. Cl. 442/149; 428/354

(57) ABSTRACT

An elastic compound material includes an elastic texture layer, two water-tolerant adhesive layers respectively and securely attached to opposite sides of the elastic texture layer and two elastic surface layers respectively attached to one of the two water-tolerant adhesive layers. Each elastic surface layer has a breakage extension rate 450˜800%, hardness (shore 000) between 40˜80. The elastic surface layer has a thickness between 0.5˜5.0nm.

### BACKGROUND OF THE INVENTION

1. Field of the Invention

The present invention relates to a high elasticity compound material, and more particularly to a compound material having characteristics of high elasticity and thermal insulation so as to become the material for making clothing with elasticity.

2. Description of the Prior Art

Elasticity compound material has long been the raw material for making clothing with elasticity. The current known methods for making elastic clothing are as follows. One is to heat up the top side and the bottom side of a rubber foam via a machinery to allow the rubber foam to have the top side and the bottom side smooth. Then a lining or a piece of cloth is securely attached to an inner side of the rubber foam after cut to have a desired thickness such that when a wearer is wearing the finished product, the lining or the piece of cloth provides comfort to the wearer. When considering the product making process, it is noted that the rubber foam is sliced to the desired thickness such that the remaining rubber foam becomes waste. In addition, the texture of the lining or the piece of cloth is loose so that when the lining or the piece of cloth is attached to the surface of the sliced rubber foam, the glue used to attach the lining or the piece of cloth to the surface of the rubber foam may flow out of the seam between the rubber foam and the lining and cause discomfort to the wearer once the product is made. Again, due to the loose texture of the lining or the piece of cloth, breakage may easily happen at the seams on the product.

The other is to attach a color adhesive on an outer surface of a rubber foam with proper thickness to form a color layer. Then a transparent foil is attached to the color layer and a lining is attached to an inner surface of the rubber foam to finish the product making process. When the clothing made by the aforementioned process is in application, the lining tend to absorb all the moisture coming out from the human body. Because the rubber foam stops the air inside the product from flowing out, the moisture absorbed is not able to be vaporized, which easily leads to hypothermia.

Furthermore, all the compound materials mentioned above are made from rubber foam of low elasticity and great hardness so that even after the product (the clothing) is finished, the wearer is not comfortable in both processes of putting on and taking off the clothing.

To overcome the shortcomings, the present invention tends to provide an improved compound material to mitigate the aforementioned problems.

### SUMMARY OF THE INVENTION

The primary objective of the present invention is to provide a compound material with high elasticity and thermal insulation features so that the compound material is able for clothing with elasticity.

In order to accomplish the aforementioned objective, the compound material in accordance with the present invention includes:

an elastic texture layer;

two water-tolerant adhesive layers respectively attached to opposite sides of the texture layer; and

two elastic surface layers respectively formed on top of each of the two water-tolerant adhesive layers.

Another objective of the present invention is to provide a compound material with good surface smoothness and low water absorption rate, which are mainly based on the implementation of a heated metal grid on the surface layers so as to form a continuous pattern. A coating having the ingredient of polyurethane is coated outside the surface layers such that based on the softness, durability and anti-corrosion features of the coated polyurethane layer, the compound material of the present invention has low water absorption rate.

Furthermore, each surface layer is composed of polychloroprene (chloroprene rubber), which has high elasticity, so that when the compound material is used to make clothing, discomfort to the wearer is decreased.

Still a further objective of the present invention is to provide secured combination between elements of the compound material. The water-tolerant adhesive layer is composed of polychloroprene and polycynante. Because the polycynante has excellent water tolerance (no corrosion or cracking after immersed in NaOH solution of 10% concentration for 24 hours), the water-tolerant adhesive layer is able to hold the elements of the compound material together without being influenced by the variations of the environmental conditions.

Another objective of the present invention is that the elastic texture layer is composed of nylon and elastic yarn. Because the breakage extension rate (ratio between a normal length and a maximum length before breakage after being extended) of the elastic texture layer is above 450% and the structure thereof is hexagonal in cross section, after the elastic texture layer is sandwiched by the two surface layers, air contained inside the elastic texture layer is securely enclosed. Thus the compound material of the present invention has high thermal insulation.

In yet another objective of the present invention is that the bonding strength in the seams of the clothing made by the compound material is strong due to the high elasticity of the elastic texture layer.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the structure of the compound material of the present invention; and

FIG. 2 is an exploded perspective view of the structure of the compound material of the present invention.

### DETAILED DESCRIPTION OF THE PREFERRED EMBODIMENT

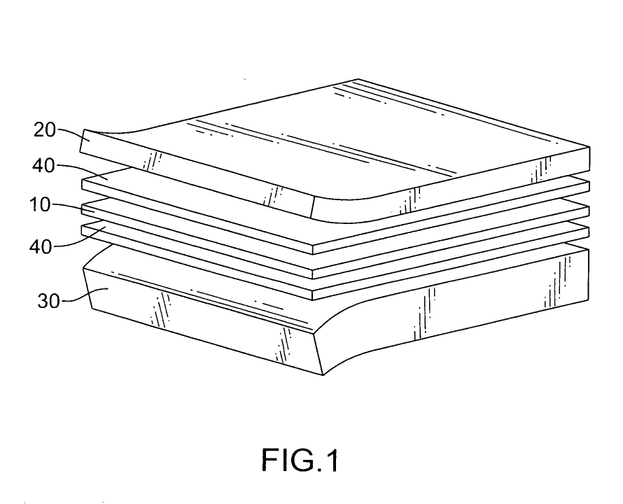

With reference to FIG. 1, it is noted that the compound material in accordance with the present invention includes an elastic texture layer (10), two water-tolerant adhesive layers (40) respectively attached to opposite sides of the texture layer (10) and two elastic surface layers (20,30) respectively formed on top of each of the two water-tolerant adhesive layers (40).

The elastic texture layer (10) is composed of nylon and elastic yarn. Due to the structure thereof in cross section is hexagon, after the elastic texture layer (10) is sandwiched by the two elastic surface layers (20,30), the air contained inside the elastic texture layer (10) is securely confined by the two elastic surface layers (20,30) so that the thermal insulation characteristic is good. Besides, because the elastic texture layer (10) has excellent elasticity, when the finished product is used to make clothing, the strength of seams on the clothing is strong.

The water-tolerant adhesive layer (40) is composed of polychloroprene and polycynante. The polycynante has 5% of volume of the adhesive layer (40) and is resistant to water so that the water-tolerant adhesive layer (40) is able to resist corrosion from acid and alkali.

Each surface layer (20,30) is composed primarily of polychloroprene and other agents to form a foaming material with a desired thickness after addition of sulfur. The breakage extension rate (ratio between a normal length and a maximum length before breakage after being extended) of the surface layer (20,30) is between 710˜750%, the hardness (shore 000) thereof is 54 degrees and thickness is between 1.5˜3.5 mm.

It is noted from the above description that after the water-tolerant adhesive layers (40) are securely attached to opposite sides of the elastic texture layer (10) and before they dry out, each of the elastic surface layers (20,30) is attached to a corresponding one of the two water-tolerant adhesive layers (40). After a heating and then a cooling process, the compound material of the present invention is ready for use.

Further, the breakage extension rate of the water-tolerant adhesive layer (40) is 550%. The longitudinal breakage extension rate of the elastic texture layer (10) which has 90% of nylon in volume is about 720% and the thickness is about 0.8 mm. The elastic texture layer (10) has about 100˜150 textured voids every square centimeter (100˜150 voids/cm²) and has 50˜70 water repelling quality (AATCC 22, dripping water drops onto a texture surface to test its permeability).

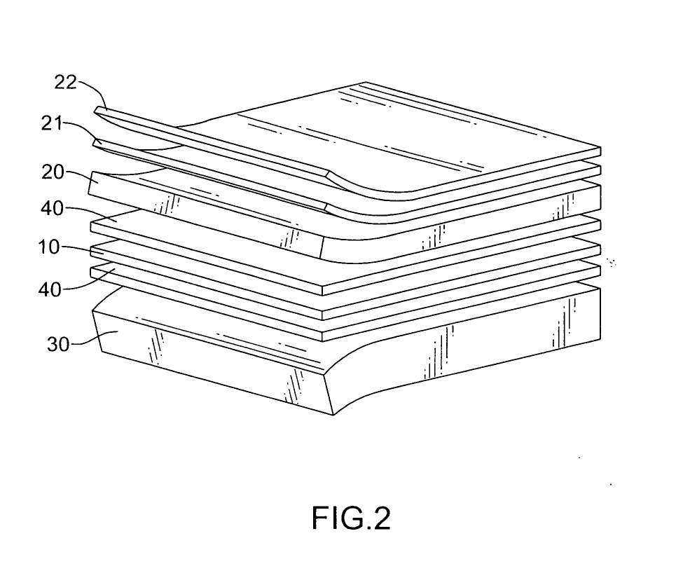

With reference to FIG. 2, it is to be noted that a coating layer (21) composed of polyurethane is coated onto the elastic surface layer (20) such that based on the softness, durability and anti-corrosion features of the coated polyurethane layer, the compound material of the present invention has low water absorption rate and high elasticity. After the coating layer (21) is coated onto the surface layer (20), the water repelling quality thereof (AATCC 22) becomes 70. The other elastic surface layer (30) has also water repelling quality 70. It is learned that the elastic surface layer (20) has a breakage extension rate 540%, hardness (shore 000) 63 degrees and thickness 1 mm. The other elastic surface layer (30) has breakage extension rate 470%, hardness (shore 000) 73 degrees and thickness 2 mm. The elastic texture layer (10) has a longitudinal breakage extension rate 590%, a latitudinal breakage extension rate 900%, thickness 0.7 mm, 400˜440 textured voids every square centimeter and water repelling quality (AATCC 22) 50.

In order to have great surface elasticity, a heated metal grid is implemented on the surface layer to form a continuous pattern thereon. Thereafter, one of the elastic surface layers (20) has a breakage extension rate 540%, hardness (shore 000) 63 degrees and thickness 1 mm. The other elastic surface layer (30) has breakage extension rate 470%, hardness (shore 000) 73 degrees and thickness 2 mm. The elastic texture layer (10) has a longitudinal breakage extension rate 590%, a latitudinal breakage extension rate 900%, thickness 0.7 mm, 400˜440 textured voids every square meter and water repelling quality (AATCC 22) 60.

In addition, an elastic cloth layer (22) is securely attached to a free side of the elastic surface layer (20) so that when the finished product made of the compound material of the present invention is worn by a wearer, the elastic cloth layer (22) is able to provide comfort to the wearer. However, to ensure the bonding between the elastic surface layer (20) and the elastic cloth layer (22), the water-tolerant adhesive layer (40) may be applied therebetween.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An elastic compound material comprising:
an elastic texture layer;
two water-tolerant adhesive layers respectively and securely attached to opposite sides of the elastic texture layer; and
two elastic surface layers respectively attached to one of the two water-tolerant adhesive layers.

2. The compound material as claimed in claim 1, wherein each elastic surface layer has a breakage extension rate 450˜800%, hardness (shore 000) between 40˜80.

3. The compound material as claimed in claim 2, wherein the elastic surface layer has a thickness between 0.5˜5.0 mm.

4. The compound material as claimed in claim 3, wherein a coating layer of polyurethane is coated outside the elastic surface layer.

5. The compound material as claimed in claim 4, wherein the elastic surface layer has a continuous pattern formed thereon.

6. The compound material as claimed in claim 5, wherein the elastic texture layer has longitudinal and latitudinal breakage extension rate between 450˜800%, thickness between 0.3˜0.9 mm, 100˜450 textured voids every square centimeter.

7. The compound material as claimed in claim 6, wherein the elastic texture layer has water repelling quality (AATCC 22) 50˜70.

8. The compound material as claimed in claim 7, wherein the elastic texture layer is composed of nylon and elastic yam.

9. The compound material as claimed in claim 1, wherein the water-tolerant adhesive layer has a breakage extension rate between 450˜750%.

10. The compound material as claimed in claim 2, wherein the water-tolerant adhesive layer has a breakage extension rate between 450˜750%.

11. The compound material as claimed in claim 3, wherein the water-tolerant adhesive layer has a breakage extension rate between 450˜750%.

12. The compound material as claimed in claim 4, wherein the water-tolerant adhesive layer has a breakage extension rate between 450˜750%.

13. The compound material as claimed in claim 5, wherein the water-tolerant adhesive layer has a breakage extension rate between 450˜750%.
